(19) United States
(12) Patent Application Publication
(10) Pub. No.: US 2021/0252670 A1
(43) Pub. Date: Aug. 19, 2021

(54) METERING VALVE FOR ABRASIVE MEDIA

(71) Applicant: Clementina Clemco Holdings, Inc., Washington, MO (US)

(72) Inventors: Ernest Gale Shafferkoetter, Villa Ridge, MO (US); Anthony James Regna, Eureka, MO (US); Thomas Lee Geer, Washington, MO (US)

(21) Appl. No.: 16/790,123

(22) Filed: Feb. 13, 2020

(51) Int. Cl. B24C 7/00; F16K 1/52

(52) U.S. Cl. CPC B24C 7/00; F16K 1/523

(57) ABSTRACT

A metering valve for introducing media into a pressurized fluid including media passaging extending through a housing. A plunger is movable between a closed position in which the plunger prevents flow of media in the media passaging and an open position in which the plunger permits flow of media in the media passaging. The plunger moving a distance between the open and closed positions. A plunger adjuster sets the distance by operatively bracing the plunger to limit movement of the plunger and changes the distance to adjust an amount of media flow permitted in the media passaging by the plunger. The plunger adjuster including an actuator to be actuated to change the distance. A bearing is operatively disposed between the actuator and the plunger and permits the actuator to be actuated to change the distance when the plunger is in the open position and operatively braced by the plunger adjuster.

### FIELD

The present disclosure generally relates to metering valves. More particularly, the disclosure relates to metering valves for abrasive media.

### BACKGROUND

Metering valves for abrasive media (e.g., media control valves) are used to control the flow of a media from a vessel containing the media into a pressurized fluid stream. Metering valves are typically used in abrasive blasting applications where the media, such as sand, glass, garnet, aluminum, etc., is introduced into the pressurized fluid stream, such as pressurized (e.g., compressed) air, which forcibly propels the media against a surface of an object.

### SUMMARY

In one aspect, a metering valve for introducing media into a pressurized fluid comprises a housing and media passaging extending through the housing. The media passaging including a media inlet for receiving media and a media outlet for dispensing media toward the pressurized fluid. A plunger is movably disposed within the housing. The plunger is movable between a closed position in which the plunger prevents flow of media in the media passaging and an open position in which the plunger permits flow of media in the media passaging. The plunger moves a distance between the open and closed positions. A plunger adjuster is configured to set the distance by operatively bracing the plunger to limit movement of the plunger as the plunger moves from the closed position to the open position. The plunger adjuster is configured to change the distance to adjust an amount of media flow permitted in the media passaging by the plunger in the open position. The plunger adjuster includes an actuator configured to be actuated to change the distance. A bearing is operatively disposed between the actuator and the plunger and is configured to permit the actuator to be actuated to change the distance when the plunger is in the open position and operatively braced by the plunger adjuster.

In another aspect, a metering valve for introducing media into a pressurized fluid comprises a housing and media passaging extending through the housing. The media passaging includes a media inlet for receiving the media from a supply of media and a media outlet for dispensing media from the metering valve into the pressurized fluid. A valve seat defines at least a portion of the media passaging. A plunger is movable in the housing and includes a plunger head. The plunger is movable between a closed position in which the plunger head sealingly contacts the valve seat to prevent flow of media in the media passaging and an open position in which the plunger head is spaced apart from the valve seat to permit media to flow in the valve passaging toward the media outlet. The plunger head is movable distally to move the plunger head toward the valve seat to the closed position. The plunger head includes a sealing surface configured to press distally against the valve seat in the closed position for sealingly contacting the valve seat in the closed position. The plunger head comprises a polymeric material having a hardness equal to or greater than about 70 Shore A and a tensile strength less than or equal to 2500 psi.

Other objects and features will be in part apparent and in part pointed out hereinafter.

### BRIEF DESCRIPTION OF THE DRAWINGS

FIG. 1 is a perspective of a media introduction system of an abrasive blasting system including a metering valve for introducing media into a pressurized fluid, according to one embodiment of the present disclosure;

FIG. 2 is a perspective of the metering valve; and

FIG. 3 is a cross-section of the metering valve taken through line 3-3 of FIG. 2.

Corresponding parts are indicated by corresponding reference characters throughout the several views of the drawings.

### DETAILED DESCRIPTION

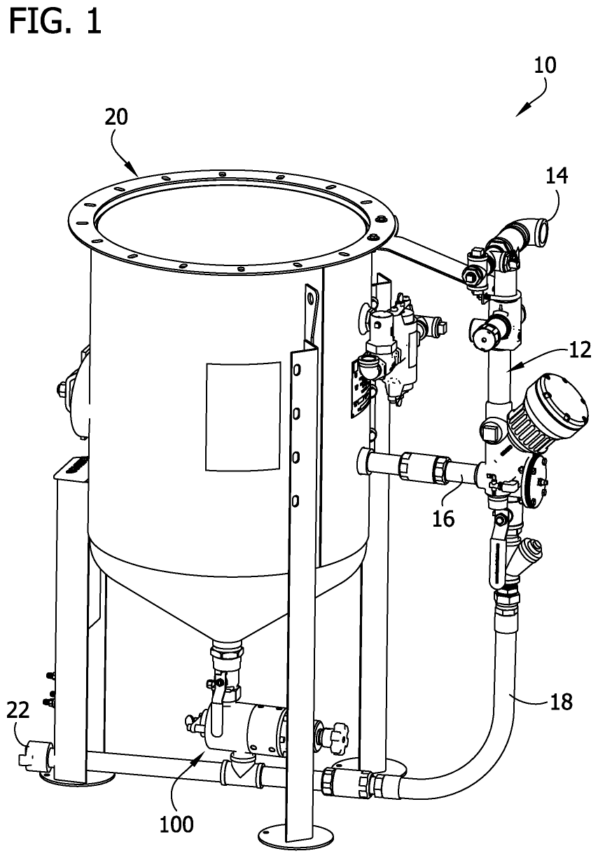

Referring to FIG. 1, a media introduction system for an abrasive blasting system constructed according to the principles of the present disclosure is generally indicated at 10. The media introduction system is used to introduce media (not shown) into a pressurized fluid (e.g., air), which then carries the media and propels or blasts the media against a surface of a component (not shown). The media introduction system 10 is a typical system for which the metering valve of the present disclosure, generally indicated at 100, may be employed with. Other configurations can be used without departing from the scope of the present disclosure.

The media introduction system 10 includes a supply line 12 that fluidly couples a fluid source (not shown), such as an air compressor, of the abrasive blasting system. The fluid source supplies the stream of pressurized fluid. In the illustrated embodiment, the supply line 12 includes a fluid stream inlet 14 configured to be fluidly coupled to the fluid source. The media introduction system 10 includes a pressure vessel or container 20 configured to hold the media (e.g., a supply of media). The supply line 12 divides into two separate lines, a pressure vessel line 16 and a pusher line 18. The pressure vessel line 16 goes to the pressure vessel 20 to pressurize the pressure vessel. The pressure vessel 20 is fluidly coupled to the pusher line 18 via the metering valve 100. The metering valve 100 controls the amount of media that enters the pusher line 18 from the pressure vessel 20. Pressurizing the pressure vessel 20 generally equalizes or balances the pressure between the pressure vessel and the pusher line 18 so that the media can flow generally by gravity from the pressure vessel, through the metering valve 100 and into the pusher line 18. In the illustrated embodiment, the pusher line 18 includes a fluid stream outlet 22 configured to be fluidly coupled to a nozzle or blast gun (not shown) of the abrasive blasting system. The nozzle or blast gun directs the pressurized fluid and entrained media at the surface of the object to be blasted. The media introduction system 10 may include several valves (e.g., check valves, ball valves, exhaust valves, etc.) to ensure the proper flow of the pressurized fluid through the media introduction system and/or for maintenance purposes.

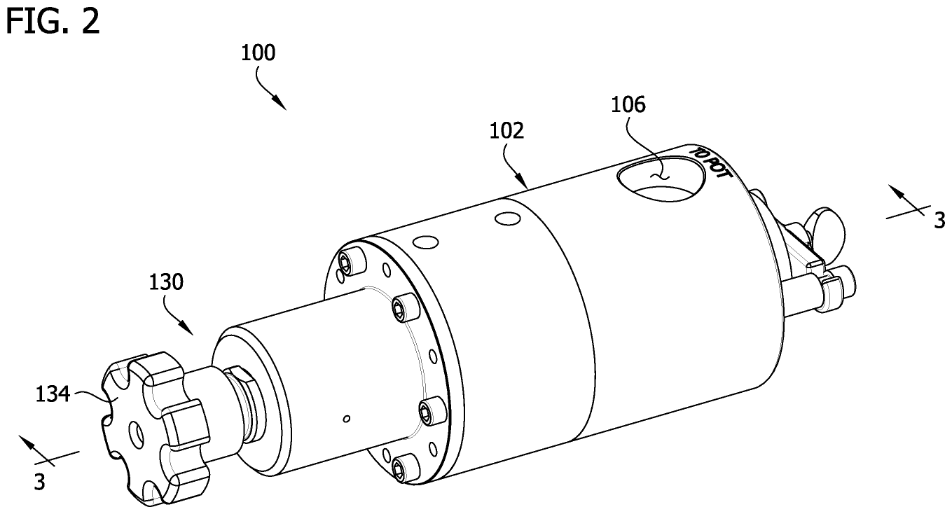

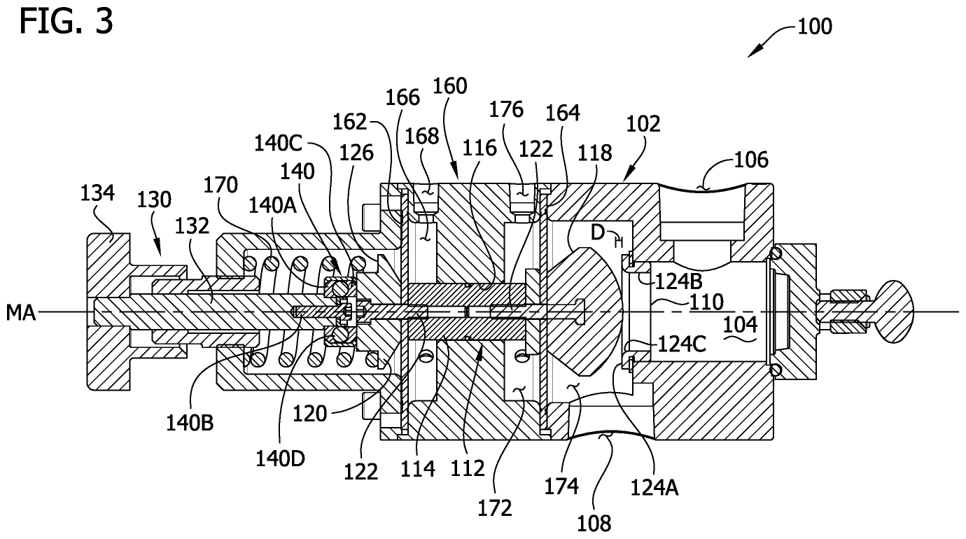

Referring to FIGS. 2 and 3, one embodiment of a metering valve for use with the media introduction system 10 is generally indicated at 100. The metering valve 100 is used to introduce media into the pressurized fluid and controls the amount of media introduced into the pressurized fluid. The metering valve 100 includes a housing 102 and media passaging 104 extending through the housing. The housing 102 may be a single piece or several pieces joined together. The media passaging 104 includes a media inlet 106 for receiving the media from the pressure vessel 20 and a media outlet 108 for dispensing the media from the metering valve into the pressurized fluid (specifically, the pressurized fluid flowing through the pusher line 18). The metering valve 100 includes a valve seat 110 that defines a portion of the media passaging 104.

The metering valve 100 includes a plunger 112 movably disposed within the housing 102. In the illustrated embodiment, the plunger 112 is linearly movable within the housing 102. In particular, the plunger 112 is axially movable along a movement axis MA. The plunger 112 is movable between a closed position (not shown) and an open position (FIG. 3). In the closed position, the plunger 112 prevents (e.g., blocks) the flow of media from the media inlet 106 to the media outlet 108. In other words, no media can flow through the metering valve 100 when the plunger 112 is in the closed position. In the open position, the plunger 112 does not prevent the flow of media from the media inlet 106 to the media outlet 108. In other words, media is permitted (e.g., allowed) to flow through the metering valve 100 when the plunger 112 is in the open position.

The plunger 112 includes a plunger shaft 114 slidably mounted within a shaft opening 116 of the housing 102. The plunger 112 includes a plunger head 118 secured to a distal end of the plunger shaft 114 and a plunger tail 120 secured to a proximal end of the plunger shaft. Fasteners 122 secure the plunger head and tail 118, 120 to the plunger shaft 114. The plunger head 118 defines a distal end (e.g., a distal exterior surface) of the plunger 112 and the plunger tail 120 defines a proximal end (e.g., a proximal exterior surface) of the plunger. The plunger head 118 is movable distally in a distal direction (e.g., along the movement axis MA toward the valve seat 110) toward the closed position and movable proximally in a proximal direction (e.g., along the movement axis MA away from the valve seat) toward the open position. In the closed position, an annular distally facing area (broadly, “sealing surface”) of the plunger head 118 presses distally against the valve seat 100 to sealingly contact (e.g., engage) the valve seat, which prevents flow of media from the media inlet 106 to the media outlet 108. In the illustrated embodiment, the distal exterior surface of the plunger head 118 has a generally domed shape (e.g., convex dome shape) to facilitate the formation of the annular seal with the valve seat 110. The valve seat 110 includes a proximal flange 124A, a distal neck 124B, and a radiused annular portion 124C connecting the flange to the neck. In the closed position of the plunger, the sealing surface of the plunger head 118 presses distally against the valve seat 110 on the radiused annular portion 124B, and optionally the flange 124A, to form a “face seal” with and plug the valve seat 110. Other configurations can be used without departing from the scope of the present disclosure. In the open position, the plunger head 118 (e.g., distal end of the plunger 112) is spaced apart from the valve seat 110 to permit the flow of gas and media from the media inlet 106 to the media outlet 108. In particular, the distal end of the plunger 112 is spaced apart from the valve seat 110 by a distance D. The distance D is adjustable and is the distance the plunger moves between the opened and closed positions. Moreover, the distance D corresponds to the amount of media introduced by the metering valve 110 into the pressurized fluid. Generally, the larger the distance D between the valve seat 110 and the plunger 112, the greater the amount of media introduced into the pressurized fluid.

The plunger head 118 is configured to withstand the abrasive effect of the media as the media moves through the metering valve 100. When the plunger 112 is in the open position, the media flows between the valve seat 110 and plunger head 118 as the media moves to the media outlet 108. This movement of the media along the plunger head 118 can wear down (e.g., abrade) and/or damage the plunger head and, as a result, the plunger head may fail to provide a seal with the valve seat 110 (e.g., the damaged plunger head may fail to close the metering valve 100). To ensure the plunger head 118 can withstand the abrasive effect of the media, the plunger head 118 is made of a polymeric material having a hardness (e.g., durometer) equal to or greater than about 70 Shore A, or even more desirably, greater than or equal to about 85 Shore A, or even more desirably about 90 Shore A (+/−5 Shore A). The plunger head 118 having a hardness equal to or greater than about 70 Shore A ensures that the surface of the plunger head 118 can withstand and not be damaged by the movement of the media through the metering valve 100 and will not be impregnated by media in the outer surface of the plunger head when moved to the closed position (e.g., media embedded in plunger head 118). A plunger head made from a material having a hardness less than about 70 Shore A is too soft and will be worn down and/or impregnated by the media, causing discontinuities in the sealing surface of the plunger head. This prevents the plunger head from forming a seal with the valve seat, reducing the life of the metering valve.

In addition, the polymeric material of the plunger head 118 has inherent flexibility (e.g., resilient compressibility, pliability, deformability) which facilitates the forming of the seal when the plunger head 118 is pressed against the valve seat 110. Desirably, the polymeric material has a tensile strength, which corresponds to the resilient compressibility of the polymeric material, that is less than or equal to about 2500 psi (the lower the tensile strength the more compressible). Conventional plunger heads made of metal, such as tungsten carbide, are generally rigid and provide no such flexibility. Conventional thought is that the plunger head has to be generally rigid (e.g., have a high tensile strength) to apply enough pressure against the valve seat in order to close the valve. Moreover, some conventional valves have a spool-type plunger that slides in a spool passage instead of pressing against a face of a valve seat to form a seal, so the design criteria for the spool-type valves are different from the presently disclosed valve. Using a polymeric material with a hardness equal to or greater than about 70 Shore A allows the plunger head to have a hardness great enough to resist the abrasive effect of the moving media and resist puncturing of the surface with the media, while having a tensile strength less than or equal to about 2500 psi gives the plunger head the pliability to form a seal with the valve seat 110. The plunger head 118 has to form a seal with the valve seat 110 over any media that may become trapped between the plunger head and valve seat. The resilient compressibility of the plunger head 118 enables the plunger head to deform over any such trapped media and form a seal with the valve seat 110. For example, the plunger head 118, when pressed against the valve seat 100, can be resiliently compressed to temporarily reduce its length along the movement axis MA. Moreover, it is believed that the flexibility of the polymeric material helps to further negate the abrasive effect of the media as the media moves along the plunger head 118 and enables the plunger head to continue to form a seal with the valve seat 110 even if the plunger head is damaged by the media.

In one embodiment, the polymeric material forming the plunger head 118 is a high-strength hardened (e.g., cured) urethane. For example, the plunger head can comprise a urethane elastomer polymer having a hardness of about 90 (+/−2) Shore A (broadly, about 80 or greater Shore A), ultimate tensile strength of about 2100 psi (broadly less than 5,800 psi, or, more desirably, less than 2,500 psi), and elongation of about 600% (broadly, at least 200%, or at least 400%). In the illustrated embodiment, a body of the plunger head 118 is entirely made of the polymeric material. The plunger head comprising a high percentage by mass (e.g., at least 70% or at least 80%) of polymeric material is desirable to maximize the flexibility (e.g., resilient compressibility) of the plunger head 118. Alternatively, the plunger head 118 may comprise a polymeric material on a non-polymeric substrate (e.g., overmolded).

Tests were conducted to compare a metering valve with a plunger head made of a plunger head material having a hardness of 90 (+/−5) Shore A and a tensile strength of 5,800 psi and the metering valve 100 as described herein with a plunger head made of high-strength hardened urethane, as described above (e.g., a hardness of 90 (+/−2) Shore A and a tensile strength of 2,100 psi). In the tests, media was continuously moved through the metering valves to determine how long the valves could control the flow of media before they failed. Failure is the inability for the plunger head to form a seal with the valve seat (e.g., the valve leaks when closed). In the tests, the valve with a plunger head made from the 5,800 psi material failed after about 5 hours of running media through the valve. However, the metering valve 100 having the 2,100 psi material ran for more than 100 hours and did not fail. Thus, a metering valve 100 constructed according to the teachings herein has an functional life that is more than at least 20 times the functional life of other metering valves.

Still referring to FIGS. 2 and 3, the metering valve 100 includes a plunger adjuster 130 that sets the amount of media the metering valve introduces into the pressurized fluid in the pusher line 18. In the illustrated embodiment, the plunger adjuster 130 is configured to set the distance D the plunger 112 moves between the open and closed positions. This allows the plunger adjuster 130 to control the distance D between the plunger head 118 and the valve seat 110, thereby controlling the amount of media permitted to move through the metering valve 100. The plunger adjuster 130 operatively braces the plunger 112, when the plunger is in the open position (FIG. 3), to set the distance D. By operatively bracing the plunger 112, the plunger adjuster 130 limits (e.g., stops) the movement of the plunger as the plunger moves (e.g., moves proximally) from the closed position to the open position. The plunger 112 is in the open position when the plunger is operatively braced against the plunger adjuster 130 and is inhibited from moving farther in the proximal direction (e.g., away from the valve seat).

The plunger adjuster 130 is also configured to adjust the amount of media the metering valve 130 introduces into the pressurized fluid. The plunger adjuster 130 is configured to change the distance D to adjust the amount of media flowing into the pressurized fluid when the plunger 112 is in the open position. In particular, the plunger adjuster 130 is configured to change the location or point at which the plunger 112 is operatively braced against the plunger adjuster, thereby changing the location of the open position of the plunger. The plunger adjuster 130 includes an actuator 134 configured to be actuated (e.g., manually moved) to change the distance D.

In the illustrated embodiment, the plunger adjuster 130 includes a threaded adjustment shaft 132 threadably coupled to the housing 102. Moreover, in the illustrated embodiment, the actuator 134 comprises a knob mounted to the threaded adjustment shaft 132 (e.g., a proximal end thereof). The knob 134 is configured to be rotated (e.g., manually rotated) to change the distance D. The knob 134 is secured to the threaded adjustment shaft 132 for conjoint rotation such that as the knob rotates, so does the threaded adjustment shaft. For example, as the knob 134 is rotated in one direction (e.g., clockwise), the threaded adjustment shaft 132 also rotates in the same direction, thereby moving distally relative to the housing 102 and shortening the permitted distance D. Similarly, as the knob 134 is rotated in the opposite direction (e.g., counter-clockwise), the threaded adjustment shaft 132 also rotates in the same direction, thereby moving proximally relative to the housing 102 and increasing the permitted distance D.

The metering valve 100 includes a bearing 140 to permit the distance D between the plunger head 118 and the valve seat 110 to be changed when the plunger is in the open position. The bearing 140 is operatively disposed between the actuator 134 and the plunger 112. Specifically, the bearing 140 is disposed between the plunger 112 and the portion of the threaded adjustment shaft 132 threadably engaging the housing 102. The bearing 140 facilitates actuation of the actuator 134 to change the distance D when the plunger 112 is in the open position and operatively braced against the plunger adjuster 130. As explained in more detail below, the plunger 112 is moved to and held in the open position via pressurized fluid. As a result, a large amount of force (e.g., 700 lb) is pushing the plunger 112 operatively against the plunger adjuster 130. Without the bearing 140, this large amount of force against the plunger adjuster 130 would generate a large amount of fiction on the plunger adjuster that would substantially restrict the plunger adjuster from being able to change the distance D when the plunger is in the open position under fluid pressure. Because a large amount of force (e.g., 700 lb.) applied against the plunger adjuster, it is not generally possible to manually change the distance D in conventional metering valves when the plunger is in the open position. However, operatively positioning the bearing 140 between the plunger 112 and the actuator 134 substantially reduces the friction restricting movement of the plunger adjuster, allowing the actuator to be manually actuated to change the distance D when the plunger is in the open position. Specifically, the bearing 140 allows the actuator 134 and threaded adjustment shaft 132 to be manually rotated to change the distance D, even if the plunger 112 is in the open position and biased distally by substantial fluid pressure.

In the illustrated embodiment, the bearing 140 is mounted on a distal end of the plunger adjuster 130. Specifically, the bearing 140 is mounted on a distal end of the threaded adjustment shaft 132. In this embodiment, the plunger 112 engages the bearing 140 when the plunger is in the open position (FIG. 3). Specifically, the proximal end of the plunger 112 defined by the plunger tail 120 engages the bearing 140. In this embodiment, the plunger adjuster 130 moves the bearing 140, relative to the housing 102, to change the distance D to adjust the amount of media flowing in to the pressurized fluid when the plunger 112 is in the open position. Broadly, the bearing 140 defines a bracing surface that engages the plunger 112 when the plunger is in the open position to set the distance D. By moving the bracing surface, via the plunger adjuster 130, the distance D is changed.

Desirably, the bearing 140 is a thrust bearing designed to support axial loads, such as the load placed on bearing 140 by pressurized fluid forcing the plunger 112 proximally. The bearing 140 includes a first race 140A secured by a fastener 140B (e.g., screw) to the plunger adjuster 130, a second race 140C which defines the surface of the bearing that operatively braces the plunger 112 (in the illustrated embodiment, engages the tail of the plunger), and a plurality of ball bearings 140D between the first and second races. The arrangement is such that the second race 140C is permitted by the ball bearings 140D to rotate with respect to the first race 140A and the plunger adjuster 130. When there is great force pressing the plunger 112 against the second race 140C, the plunger adjuster 130 can still be rotated because of the ball bearings 140D between the races. The bearing 140 permits the actuator 134 to be rotated (e.g., manually rotated) to move the threaded adjustment shaft 132 proximally or distally to change the distance D to adjust the amount of media being introduced in to the pressurized fluid by the metering valve 100 while the metering valve is introducing media into the pressurized fluid (e.g., while the plunger 112 is in the open position). Specifically, the bearing 140 allows the threaded adjustment shaft 132 to rotate while the plunger 112 is operatively braced by the plunger adjuster 130. This allows an operator to manually adjust the amount of media being introduced by the metering valve 100 while the metering valve is open and the system is operating under pressure.

The bearing surface may be defined by a component other than the bearing 140. It is understood, the bearing 140 may be disposed at other positions. For example, the bearing 140 could be incorporated into the plunger 112 (e.g., disposed at or near the proximal end of the plunger) or incorporated into the threaded adjustment shaft 132. Thus, in other embodiments, the plunger 112 may engage and be directly braced by the plunger adjuster 130.

Still referring to FIG. 3, the metering valve 100 includes a valve actuator 160. The valve actuator 160 is operatively coupled to the plunger 112 and configured to move or facilitate the movement of the plunger 112 into the open and closed positions. Broadly, the valve actuator 160 is configured to move the plunger 112 to at least one of the open position or the closed position. Desirably, the valve actuator 160 can move the plunger 112 to both the open and closed positions. The valve actuator 160 includes first and second diaphragms 162, 164 (e.g., elastomeric diaphragms) spanning the interior of the housing 102 (broadly, at least one diaphragm). The peripheral edge of each diaphragm 162, 164 is sealingly coupled to the housing. Each diaphragm 162, 164 is coupled (e.g., operatively coupled) to the plunger 112 and is configured to move the plunger to at least one of the open position or the closed position. Together the housing 102 and first diaphragm 162 define a first or pressure open chamber 166. The first chamber 166 is fluidly connected to a source of pressurized fluid (e.g., air) through a port 168. The source of pressurized fluid may be the same as or different from the fluid source that provides the pressurized fluid flowing through the supply line 12. The addition of pressurized fluid into the first chamber 166 moves the first diaphragm 162 and plunger 112 proximally, away from the valve seat 110, toward the plunger adjuster 130 and to the open position. The addition of the pressurized fluid moves the plunger 112 proximally until the plunger is operatively braced by the plunger adjuster and positioned in the open position (e.g., the metering valve 100 is pressurized open). In the illustrated embodiment, the valve actuator 160 includes a spring 170 that biases the plunger 112 toward the closed position. In this embodiment, the spring 170 engages a shoulder 126 of the plunger tail 120 to bias the plunger 112. The addition of pressurized fluid into the first chamber 166 is sufficient to overcome the biasing force from the spring 170. When the pressurized fluid is exhausted from the first chamber 164 through the port 168, the spring 170 moves the plunger 112 distally to the closed position when the passaging 104 is not pressurized.

Together the housing 102 and second diaphragm 164 define a second or pressure close chamber 172 and a media chamber 174. The second diaphragm 164 divides the interior of the housing 102 to separate the second chamber 172 and the media chamber 174. The media camber 174 is, broadly, part of the media passaging 104. As explained in more detail below, the second chamber 172 is used to move the plunger 112 to the closed position and the media chamber 174 is used to move the plunger to the open position. The second chamber 172 is fluidly connected to a source of pressurized fluid (e.g., air) through a port 176, similar to the first chamber 166 as discussed above. The addition of pressurized fluid into the second chamber 172 moves the second diaphragm 164 and plunger 112 distally, away from the plunger adjuster 130, toward the valve seat 110 and to the closed position. The plunger 112 moves distally until the plunger head 118 engages the valve seat 110 in the closed position (e.g., the metering valve 100 is pressurized closed). When the pressurized fluid is exhausted from the second chamber 172 (e.g., through the port 176), the plunger 112 is free to move distally to the open position.

The media chamber 174 is used during the normal operation of the metering valve 100 to move (e.g., facilitate the movement of) the plunger 112 to the open position. Before the media introduction system 10 is pressurized by the pressurized fluid carried by the supply line 12, the plunger 112 is in the closed position (e.g., the metering valve 100 is closed). As the media introduction system 10 is pressurized, the pressurized fluid delivered to the media vessel 20 via the pressure vessel line 16 moves into the metering valve 100. This pressurized fluid moves into the media passaging 104 through the media inlet 106. The addition of the pressurized fluid to the media passaging 104 pushes against the plunger head 118 and moves the plunger 112 proximally, away from the valve seat 110, toward the open position. Additionally, pressurized fluid may be delivered via port 168 to the first chamber 166 to push the first diaphragm 162 proximally to move the plunger head 118 toward the open position. It is understood the pressurized fluid in the media passaging 104 and/or the first chamber 166 may be used to move the plunger head 118 toward the open position. As the plunger head 118 is moved proximally, the seal between the plunger head and the valve seat 110 is broken, allowing the pressurized fluid to enter the media chamber 174. This pressurized fluid to the media chamber 174 continues to move and/or bias the second diaphragm 164 and plunger 112 proximally, away from the valve seat 110, toward the plunger adjuster 130 and to the open position. The pressurized fluid into the media chamber 174 moves (e.g., assists in moving) the plunger 112 proximally until the plunger is operatively braced by the plunger adjuster 130 (e.g., engages the bracing surface) and positioned in the open position.

In the open position, a controlled amount of media flows between the plunger head 118 and the valve seat 110, out the media outlet 108 and into the pressurized fluid flowing through the pusher line 18. When the media introduction system 10 is no longer pressurized, the spring 170 moves the plunger 112 distally to the closed position. In one embodiment, if the media introduction system 10 is no longer being used (e.g., actively delivering media) but still pressurized, a pressurized fluid may be delivered via port 176 to the second chamber 172 to push (along with the spring 170) the second diaphragm 164, and therefore the plunger 112, distally to the closed position. In this embodiment, to permit the plunger 112 to move back toward the open position, the second chamber 172 is vented.

It will be apparent that modifications and variations are possible without departing from the scope of the invention defined in the appended claims.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products without departing from the scope of the claims, it is intended that all matter contained in the above description and shown in the accompanying drawings shall be interpreted as illustrative and not in a limiting sense.

What is claimed is:

1. A metering valve for introducing media into a pressurized fluid, the metering valve comprising:
a housing,
media passaging extending through the housing, the media passaging including a media inlet for receiving media and a media outlet for dispensing media toward the pressurized fluid,
a plunger movably disposed within the housing, the plunger movable between a closed position in which the plunger prevents flow of media in the media passaging and an open position in which the plunger permits flow of media in the media passaging, wherein the plunger moves a distance between the open and closed positions;
a plunger adjuster configured to set the distance by operatively bracing the plunger to limit movement of the plunger as the plunger moves from the closed position to the open position, the plunger adjuster configured to change the distance to adjust an amount of media flow permitted in the media passaging by the plunger in the open position, the plunger adjuster including an actuator configured to be actuated to change the distance; and
a bearing operatively disposed between the actuator and the plunger and configured to permit the actuator to be actuated to change the distance when the plunger is in the open position and operatively braced by the plunger adjuster.

2. The metering valve of claim 1, wherein the bearing is a thrust bearing.

3. The metering valve of claim 1, wherein the bearing is mounted on the plunger adjuster.

4. The metering valve of claim 3, wherein the bearing is arranged to engage the plunger when the plunger is in the open position to operatively brace the plunger.

5. The metering valve of claim 4, wherein the plunger adjuster moves the bearing to change the distance to adjust the amount of media flow permitted in the media passaging by the plunger when the plunger is in the open position.

6. The metering valve of claim 1, wherein the plunger adjuster includes a threaded adjustment shaft threadably coupled to the housing, the adjustment shaft operatively coupled to the bearing and to the actuator such that the adjustment shaft rotates relative to the housing to move the bearing to change the distance when the actuator is actuated.

7. The metering valve of claim 6, wherein the bearing is mounted on the adjustment shaft.

8. The metering valve of claim 1, wherein the actuator is a knob configured to be rotated to change the distance.

9. The metering valve of claim 1, wherein the plunger is linearly movable from the closed position to the open position.

10. The metering valve of claim 1, further comprising a valve actuator operatively coupled to the plunger and configured to move the plunger to at least one of the open position or the closed position.

11. The metering valve of claim 10, wherein the valve actuator includes at least one diaphragm coupled to the plunger configured to move the plunger toward at least one of the open position or the closed position.

12. The metering valve of claim 11, wherein the at least one diaphragm is configured to move the plunger toward the open position and the closed position.

13. The metering valve of claim 1, further comprising a valve seat defining at least a portion of the media passaging, wherein the plunger includes a plunger head, the plunger head configured to sealingly contact the valve seat to prevent flow of media in the valve passaging when the plunger is in the closed position, the plunger head comprising a polymeric material having a hardness equal to or greater than about 70 Shore A.

14. The metering valve of claim 1, in combination with a pressure vessel configured to hold the supply of media.

15. A metering valve for introducing media into a pressurized fluid, the metering valve comprising:
a housing,
media passaging extending through the housing, the media passaging including a media inlet for receiving the media from a supply of media and a media outlet for dispensing media from the metering valve into the pressurized fluid,
a valve seat defining at least a portion of the media passaging,
a plunger movable in the housing and including a plunger head, the plunger movable between a closed position in which the plunger head sealingly contacts the valve seat to prevent flow of media in the media passaging and an open position in which the plunger head is spaced apart from the valve seat to permit media to flow in the valve passaging toward the media outlet, the plunger head being movable distally to move the plunger head toward the valve seat to the closed position, the plunger head including a sealing surface configured to press distally against the valve seat in the closed position for sealingly contacting the valve seat in the closed position;
wherein the plunger head comprises a polymeric material having a hardness equal to or greater than about 70 Shore A and a tensile strength less than or equal to 2500 psi.

16. The metering valve of claim 15, wherein the polymeric material is a hardened urethane.

17. The metering valve of claim 15, wherein the plunger head comprises a body formed of the polymeric material, the body sized and shaped to be resiliently compressed when the sealing surface is pressed distally against the valve seat to sealingly contact the valve seat in the closed position.

18. The metering valve of claim 15, wherein the plunger is linearly movable in a distal direction to move the plunger distally toward the closed position, the sealing surface facing generally in the distal direction.

19. The metering valve of claim 18, further comprising a plunger adjuster configured to adjust the amount of media flowing into the pressurized fluid when the plunger is in the open position, the plunger adjuster including an actuator configured to be actuated to change the amount of media flowing into the pressurized fluid.

20. The metering valve of claim 19, further comprising a bearing operatively disposed between the actuator and the plunger head and configured to permit the actuator to be actuated when the plunger is in the open position to adjust the amount of media flowing into the pressurized fluid.
